(19) United States
(12) Patent Application Publication
(10) Pub. No.: US 2007/0187944 A1
(43) Pub. Date: Aug. 16, 2007

(54) Map squared

(76) Inventor: Kaj Berndtson, Schoengeising (DE)

Correspondence Address: Kaj Berndtson, Enterbruck 11, Schoengeising, D-82296, DE

(21) Appl. No.: 11/228,432

(22) Filed: Sep. 19, 2005

(30) Foreign Application Priority Data
Sep. 19, 2004 (DE) 20 2004 014 769.6
Feb. 11, 2005 (DE) 20 2005 002 220.9

(51) Int. Cl. G09B 29/00

(52) U.S. Cl. 283/34

(57) ABSTRACT

A map, having a printed sheet of paper or synthetic paper and optionally having a lamination or lining on one or both sides, and having fanfold lines extending in one direction and at least two cross folds extending perpendicular to the fanfold lines. One at the top, forming the map spine, and the other at lowest a edge of the map. Such a map has in the final folded format preferably a square or approximately square format. The cross fold at lowest edge of the map forms a smooth edge of the map and a step formed by a shorter front outer map surface in vertical direction as the one in the back. This step forms a narrow horizontal surface with a vertical height of 1 to 100 mm and being imprinable. Optional there are further cross folds at the ends of the map surfaces multiplying the printable surface.

The invention relates to a map, which has in the cross folded format a preferably square or approximately square format, as e.g. a country map, a road map, a street map, a city map, a hiking map, a bike map, a mountain bike map, motor cycle map, a public transport map, a nautical chart, a aviation chart, a pilotage chart, a geological chart, a achitectural plan, but also an information sheet, which is printed on a large sheet and is folded like map to a small and easy manageable format and an otherwise printed map sheet.

“Known maps” have various embodiments, whereas those are predominant where the map sheet is made of printed paper, card, sythetic paper or synthetics. Such maps produced of the first two materials ware comparably fast. For said reason, maps are known where the paper/card sheet is finished by coating or lining/lamination on one or both sides with an applied transparent plastic film. Said map sheet is folded machine-made or by hand to a smaller and easier manageable format. It's considered standard of technology, that printed map sheets made of paper, card, sythetic paper or synthetics are embossed with grooves to predefine the folds and afterwards are completely or partly folded machine-made. Thereby the folded edges are stipulated by the embossed grooves. Said embossing can preferably happen for a map sheet with a paper weight of more than 80 g/m² is made before or after coating or lining/lamination with an applied transparent plastic film and can show numerous parallel or perpendicular grooves. The cover is printed either on the outer map surfaces of the finally folded map sheet or a separate cover made of printed paper/card sythetic paper or synthetics, which is if applicable finished by coating or lining/lamination with an applied transparent plastic film on one or both sides and is glued permanently or temporarily, laminar, spot bond or with a flap and with an appropriate glue to the finally folded map sheet. Said cover has printed an information about the contents of the map. If applicable there can be a map spine between both cover pages, a narrow, also bent surface, which connects the front and back page of the cover and is printed with a short information about the contents of the map. All said known maps have in the finally folded format and manufactored condition a rectangular format in different physical sizes. Further if applicable the known map has an outer package, which is made from a transparent film or made of printed paper, card, sythetic paper or synthetics, which is if applicable finished by coating or lining/lamination with an applied transparent plastic film on one or both sides. Said outer package is produced out of transparent plastic film by shrink wrapping or covers and/or encircles said map like a banderole in vertical or horizontal direction and which has preferably the length of a respective map edge. The drawback of the said known maps with only one cross fold on the upper edge of the map is a small printable surface and that in the area of the lower edge of the map and through the open fanfolds, they fan out and are stepped. Furtheron these said known maps can't be opened precisely in the middle of the fanfold and ripping is possible. A great drawback of the said known maps is that when displayed side by side in a sales rack, on a counter, in a drawer or in a sales stands, they only differenciate by size, design of the cover, sometimes only by a different printing and typographical manufactoring.

It is an object of this present invention to provide an embodiment of map, which has a significant distinction compared to all other maps and is obviating the above mentioned drawbacks.

To achieve these and related objects the present invention provides two embodiments of a map, which have in the finally folded format a preferably square or approximately square format, particularly for a country map, a road map, a street map, a city map, a hiking map, a bike map, a mountain bike map, motor cycle map, a public transport map, a nautical chart, a aviation chart, a pilotage chart, a geological chart, a achitectural plan, but also an information sheet, which is printed on a large sheet and is folded like map to a small and easy manageable format and an otherwise printed map sheet. The map consists of:
a printed and folded paper, card, synthetic paper or sythetics, which has preferably a paper weight of more than 80 g/m²,
a separate cover made of printed and folded paper, card, synthetic paper or sythetics, which is connected to the finally folded map sheet,
an outer package made from a transparent plastic film or from paper, card, synthetic paper or sythetics and obtional print,
an appropriate glue
a coating or a lining/lamination with with an applied transparent plastic film on the map sheet and/or the cover and/or outer package on one or both sides

In the first embodiment of the “Map Squared” it's provided according the invention, that the printed map sheet in the finally folded format has a preferably square or approximately square format. A such produced map is preferably designed for retail sales. The “Inventive Map” is a continuous printed map sheet made of paper, card, synthetic paper or sythetics, which has preferably a paper weight of more than 80 g/m², which is if applicable finished by coating or lining/lamination with an applied transparent plastic film on one or both sides, has one or multiple fanfolds and multiple cross folds in finally folded format and has optional a “cover” containing an information about the map printed on one or both sides of the outer map surfaces. Optional a narrow, also bent map spine is formed between both outer map surfaces and is printed with a short information about the contents of the map. A such produced Inventive Map shows in finally folded format a preferably square or approximately square format, whereby the length of the horizontal edge of the map compared with the length of the vertical edge of the map and measured in mm amounts a maximum of 1.2 multiples of the respective other edge of the map and vice versa. Furtheron the front outer map surface of the Inventive Map is shorter in vertical direction than the other and through the joint cross fold in the upper area, the map spine, an inventive step and a narrow horizontal surface is formed by the two lower horizontal edges of the map and the two lower sections of the vertical edges of the map. This narrow horizontal surface has in vertical direction a height of 1 up to 100 mm and is optional printed with a reference to the contents of the map, which facilitates an easy use of the finally folded map. Furtheron the lowest horizontal edge of the map is formed by cross fold and the Inventive Map thereby shows a smooth low edge of the map. Such a produced map does not fan out through the open fanfold/s and is not stepped, further it can be opened exactly in the middle of the fanfold and therewith obviates ripping. Optional the upper edge of the step, the other lower edge of the map can be formed as a cross fold and results in a further smooth edge of the map. Optional there are further one or multiple cross fold/s at the end/s of the inner map surface/s of this inventive step. Through the cross fold/s at the inventive step and optional at the end/s of the inner map surfaces the printable surface of the map sheet is multiplied accordingly, compared with a finally folded map in the same size with only one cross fold between the cover pages. If applicable such a map has an outer package, which is made from a transparent film or made of printed paper, card, sythetic paper or synthetics, which is if applicable finished by coating or lining/lamination with an applied transparent plastic film on one or both sides. Said outer package is produced of transparent plastic film by shrink wrapping or covers and/or encircles said map like a banderole in vertical or horizontal direction and has preferably the width of a respective map edge.

In the second embodiment of the “Map Squared” it's provided according the invention, that a separate cover attached to a map produced according the first embodiment. All provisions and inventions of the first embodiment of Map Squared are valid for the second embodiment and a such map is attached to a separate cover made of printed paper, card, sythetic paper or synthetics, which is if applicable finished by coating or lining/lamination with an applied transparent plastic film on one or both sides and is glued permanently or temporarily, laminar, spot bond, or with a flap and with an appropriate glue to the finally folded map sheet. Such a separate cover is optional a part of the outer package, which covers and/or encircles said map like a banderole in vertical or horizontal direction and has preferably the length of a respective map edge.

The coating of the map sheet, the separate cover, the outer package is produced by print varnish (varnishing during printing process) or by UV-varnish (hereby the varnish is applied by a calender role and hardened UV light). Also other know coatings are considered.

The lined/laminated plastic films applied the map sheet, the separate cover, the outer package are advantageously PET films (polyethylene terephthalate film) suitable for hot lamination but may alternatively be OPP films (oriented polypropylene film) for cold lamination. Other known laminating films may be considered.

The invention therefore provides means to produce a map which has a significant distinction from all other maps in the finally folded format and has further advantages. The Inventive Map has through the provided step in the lower area of the finally folded map sheet, and which has a cross fold at the lowest edge of the map, the advantage, that such a map doesn't fan out through the open fanfold/s and isn't stepped, furtheron the map can be opened exactly in the middle of the fanfold and doesn't rip when opened. Through the inventive step with further cross folds is the printable surface multiplied accordingly, compared with a map in the same finally folded format which has only one cross fold at the map spine. Such a step is optional printed with a information about the map contents, with the advantage of a easy orientation about the contents of the finally folded map. A great advantage of the Inventive Maps is, that when displayed side by side with known maps in a sales rack, on a counter, in a drawer or in a sales stands, they differenciate explicit through the provided square or approximately square format.

It's therefore provided, that the map has multiple characteristics of the invention.

### Embodiment of Map Squared

For the first embodiment of Map Squared, it's inventive provided, that printed map sheet and finally folded format has a preferably square or approximately square format. The “Inventive Map” is a continuous printed map sheet made of paper, card, synthetic paper or sythetics, which has preferably a paper weight of more than 80 g/m², which is if applicable finished by coating or lining/lamination with an applied transparent plastic film on one or both sides, has one or multiple fanfolds and multiple cross folds in finally folded format and has optional a “cover” containing an information about the map printed on one or both sides of the outer map surfaces. Optional “map spine” is formed between both outer map surfaces at the conjoint cross fold, a narrow, also bent surface, which is printed with a short information about the contents of the map. A such produced Inventive Map shows in finally folded format a preferably square or approximately square format, whereby the length of the horizontal edge of the map compared with the length of the vertical edge of the map and measured in mm amounts a maximum of 1.2 multiples of the respective other edge of the map and vice versa. Furtheron the front outer map surface of the Inventive Map is shorter in vertical direction than the other and through the conjoint cross fold in the upper area, the map spine, an inventive step and a narrow horizontal surface is formed by the two lower horizontal edges of the map and the two lower sections of the vertical edges of the map. This narrow horizontal surface has in vertical direction a height of 1 up to 100 mm and is optional printed with a reference to the contents of the map, which facilitates an easy use of the finally folded map. Furtheron the lowest horizontal edge of the map is formed by cross fold and the Inventive Map thereby shows a smooth low edge of the map. Optional the upper edge of the step, the other lower edge of the map can be formed as a cross fold and results in a further smooth edge of the map. Furtheron and optional there are further one or multiple cross fold/s at the end/s of the inner map surface/s of this inventive step. Furtheron if applicable such a map has an outer package, which is made from a transparent film or made of printed paper, card, sythetic paper or synthetics, which is if applicable finished by coating or lining/lamination with an applied transparent plastic film on one or both sides. Said outer package is produced of transparent plastic film by shrink wrapping or covers and/or encircles said map like a banderole in vertical or horizontal direction and has preferably the width of a respective map edge.

### Embodiment of Map Squared with a Separate Cover Attached

In the second embodiment of the “Map Squared” it's provided according the invention, that a separate cover attached to a map produced according the first embodiment. All provisions and inventions of the first embodiment of Map Squared are valid for the second embodiment and a such map is attached to a separate cover made of printed paper, card, sythetic paper or synthetics, which is if applicable finished by coating or lining/lamination with an applied transparent plastic film on one or both sides and is glued permanently or temporarily, laminar, spot bond, or with a flap and with an appropriate glue to the finally folded map sheet. Such a separate cover is optional a part of the outer package, which covers and/or encircles said map like a banderole in vertical or horizontal direction and has preferably the length of a respective map edge.

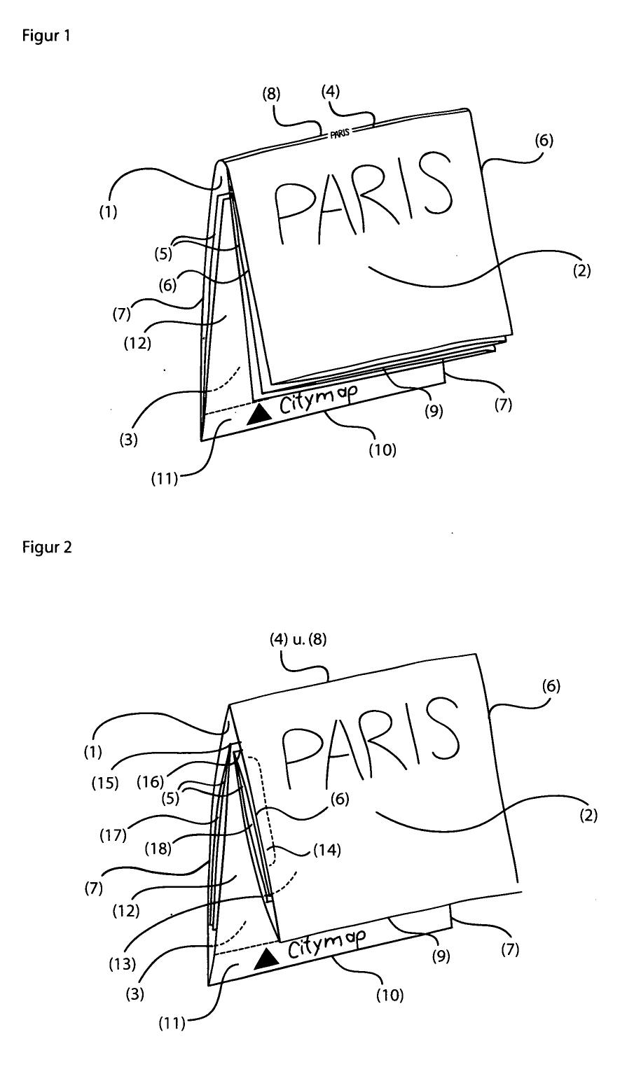

FIG. 1 shows in cavalier perspective an inventive Map Squared of Paris with a cross fold at the lowest edge of the map

FIG. 2 shows in cavalier perspective an inventive Map Squared of Paris a with a cross fold at both lower horizontal edges of the map and further cross folds at the ends of the inner map surfaces

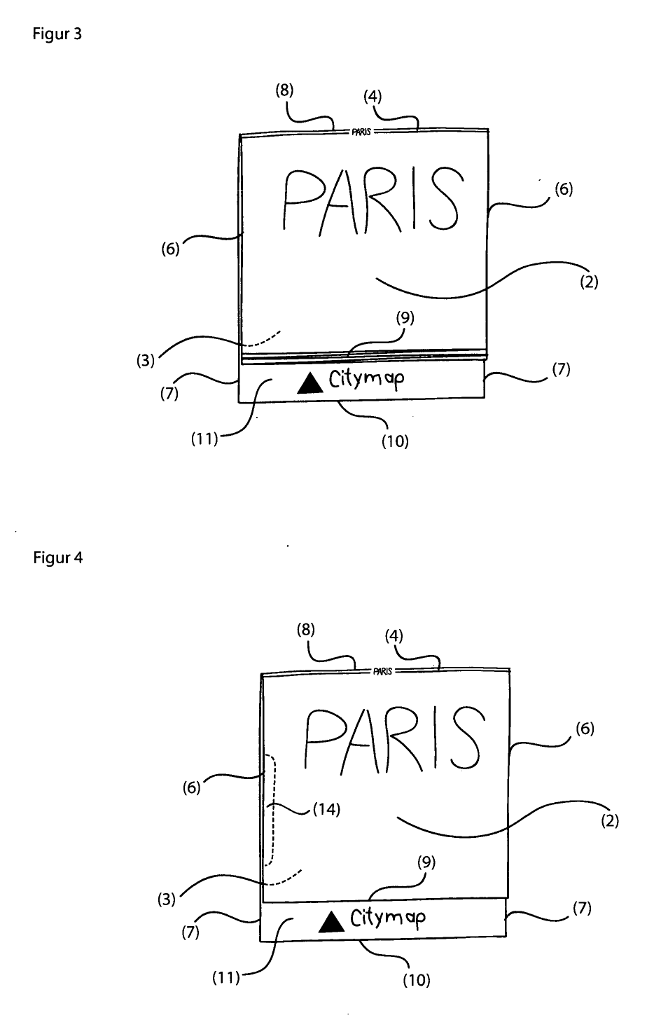

FIG. 3 shows in front perspective an inventive Map Squared of Paris with a cross fold at the lowest edge of the map

FIG. 4 shows in front perspective an inventive Map Squared of Paris a with a cross fold at both lower horizontal edges of the map

FIG. 1 shows in cavalier perspective an inventive Map Squared of Paris with a cross fold at the lowest edge of the map

The map sheet (1) is in the finally folded format and has a front outer map surface (2), the front cover page and a back outer map surface (3), the back cover page. Between these both map surfaces at the joint cross fold a narrow bent map spine (4) is formed, its printed with the short information “Paris” and which is visible from the top. The map has multiple fanfolds (5), in front the short vertical edge of the map (6) and in back the long vertical edge of the map (7). The cross fold (4) forms at the top the upper horizontal edge of the map (8). From top to bottom the next horizontal edge of the map (9) forms together with the lowest smooth edge of the map (10), a cross fold, and bordered with the lower section of both long vertical edges of the map (7) a step and a narrow horizontal surface (11), printed with “Citymap”. At the horizontal edge of the map (9) the fanfold fans out and is stepped. Through the cross fold a smooth lowest horizontal edge of the map (10) and inwards the inner map surface (12) are formed.

FIG. 2 shows in cavalier perspective an inventive Map Squared of Paris a with a cross fold at both lower horizontal edges of the map and further cross folds at the ends of the inner map surfaces

The map sheet (1) is in the finally folded format and has a front outer map surface (2), the front cover page and a back outer map surface (3), the back cover page. Between these both map surfaces at the joint cross fold a narrow pointed map spine (4) is formed. The map has multiple fanfolds (5), in front the short vertical edge of the map (6) and in back the long vertical edge of the map (7). The cross fold (4) at the top is at the same time the upper horizontal edge of the map (8). From top to bottom the next horizontal edge of the map (9) forms together with the lowest smooth edge of the map (10), both formed by a cross fold, and bordered with the lower section of both long vertical edges of the map (7) a step and a narrow horizontal surface (11), printed with “Citymap”. Through the cross fold a smooth lowest horizontal edge of the map (10) and inwards the inner map surface (12) and through a further cross fold at the horizontal edge of the map (9) and inwards the inner map surface (13) are formed. A separate cover is attached with a flap (14) to the map sheet (1). At the ends of the inner map surfaces (12) and (13) are two further cross folds (15) and (16) and form two further inner map surfaces (17) and (18).

FIG. 3 shows in front perspective an inventive Map Squared of Paris with a cross fold at the lowest edge of the map

The map sheet (1) is in the finally folded format and has a front outer map surface (2), the front cover page and a back outer map surface (3), the back cover page. Between these both map surfaces at the joint cross fold a narrow bent map spine (4) is formed, its printed with the short information “Paris” and which is visible from the top. The map has multiple fanfolds, in front the short vertical edge of the map (6) and in back the long vertical edge of the map (7). The cross fold (4) forms at the top the upper horizontal edge of the map (8). From top to bottom the next horizontal edge of the map (9) forms together with the lowest smooth edge of the map (10), a cross fold, and bordered with the lower section of both long vertical edges of the map (7) a step and a narrow horizontal surface (11), printed with “Citymap”. At the horizontal edge of the map (9) the fanfold fans out and is stepped.

FIG. 4 shows in front perspective an inventive Map Squared of Paris a with a cross fold at both lower horizontal edges of the map

The map sheet (1) is in the finally folded format and has a front outer map surface (2), the front cover page and a back outer map surface (3), the back cover page. Between these both map surfaces at the joint cross fold a narrow pointed map spine (4) is formed, its printed with the short information “Paris” and which is visible from the top. The map has multiple fanfolds, in front the short vertical edge of the map (6) and in back the long vertical edge of the map (7). The cross fold (4) at the top forms the upper horizontal edge of the map (8). From top to bottom the next horizontal edge of the map (9) forms together with the lowest smooth edge of the map (10), both formed by a cross fold, and bordered with the lower section of both long vertical edges of the map (7) a step and a narrow horizontal surface (11), printed with “Citymap”. A separate cover is attached with a flap (14) to the map sheet (1).

What is claimed:

1. A map, particularly for a country map, a road map, a street map, a city map, a hiking map, a bike map, a mountain bike map, motor cycle map, a public transport map, a nautical chart, a aviation chart, a pilotage chart, a geological chart, a achitectural plan, but also an information sheet, which is printed on a large sheet and is folded like map to a small and easy manageable format and an otherwise printed map sheet, comprising:
a printed and folded map sheet (1), made of paper, card, synthetic paper or synthetics, and
wherein the map sheet (1) in the finally folded format has multiple fanfolds and multiple cross folds and that one outer map surfaces is shorter than the other and that through the conjoint cross fold at the top, the map spine (4), a step, and a narrow horizontal surface (11) is formed, generated by the two lower horizontal edges of the map (9) and (10) and the lower section of the two long vertical edges of the map (7), which is printed or not and has a height between 1 mm to 100 mm, and that a map produced accordingly has in the folded and ready manufactored condition a rectangular format in varying sizes.
The map according to claim 1, and
wherein are two equal long horizontal edges of the map (8) and (9) and two equal long vertical edges of the map (7), and that the length of the horizontal and vertical edges of the folded map compared with each other and measured in millimeters have a maximum of 1.2 multiples of the respective other and vice versa, and that the folded map forms to a square or approximately square format in the finally folded format.

3. The map according to claim 1 or 2 and
wherein the lowest edge of the map (10) is a cross fold and a smooth edge of the map and an inner map surface (12) is formed and thereby the printable surface on the map sheet (1) is multiplied accordingly.

4. The map according to one of the claims from 1. to 3. and
wherein the lower edge of the map (9) is a cross fold and a smooth edge of the map and a inner map surface (13) is formed and through which the printable surface on the map sheet (1) is multiplied accordingly.

5. The map according to one of the claims 3. or 4. and
wherein through a cross fold at one or both ends of the inner map surfaces (12) and (13) one or two further inner map surfaces (15) and (16) are formed and thereby the printable surface on the map sheet is multiplied accordingly.

6. The map according to one of the claims from 1. to 5. and a separate cover, comprising:
a printed and folded sheet, made of paper, card, synthetic paper or synthetics, and
an appropriate glue, and
wherein this separate cover is glued with an appropriate glue permanently or temporarily, laminar, spot bond, or with a flap (14) to the finally folded map sheet (1).
The map according to claim 6. and a outer package comprising:
a printed and folded sheet, made of paper, card, synthetic paper or synthetics, and
wherein such a map is provided with a outer package, which is printed or not. The outer package is either produced from transparent plastic film by shrink wrapping or a outer package covers and/or encircles such a map like a banderole in vertical or horizontal direction and has preferably the width of a respective map edge.

8. The map according to one of the claims from 1. to 7. and a finishing comprising:
a coating or a lining/lamination with with an applied transparent plastic film on the map sheet and/or the cover and/or outer package on one or both sides and
wherein the coating is a print-varnish or UV-varnish coating or the lined/laminated transparent plastic film applied is a PET-film (polyethylene terephthalate film), for hot lamination or a OPP-film (oriented polypropylene film), for cold lamination. Other known coatings and lining/lamination films are considered for use.

9. The map according to one of the claims 1. to 8. and
wherein such a map is designed for retail sales.

10. The map according to one of the claims 1. to 9. and
wherein such a map is manufactored rotated by an angle of −90°, 90° and 180° or in any other appropriate angle.
